(19) United States
(12) Patent Application Publication
(10) Pub. No.: US 2008/0123226 A1
(43) Pub. Date: May 29, 2008

(54) Ground Fault Detector Interrupter

(76) Inventors: Patrick McGinn, Puslinch (CA); Hossein Kazemi, Burlington (CA); Luis Zubieta, Oakville (CA)

Correspondence Address: Jonathan Pollack;Gowling Lafleur Henderson LLP, Suite 1600 - 1 First Canadian Place, 100 King St. West, Toronto, ON, M5X 1G5, omitted

(21) Appl. No.: 11/944,816

(22) Filed: Nov. 26, 2007

Related U.S. Application Data
(60) Provisional application No. 60/867,144, filed on Nov. 24, 2006.

(51) Int. Cl. H02H 3/08

(52) U.S. Cl. 361/42

(57) ABSTRACT

A ground fault detector interrupter (GFDI) is described. The GFDI configured for use with a DC power supply and comprises the following elements. A ground current path is provided for coupling a ground terminal of the DC power supply and a system ground. A grounding switch is placed in the ground current path. A current detector is configured to detect a ground current in the ground current path. A controller is configured to compare the ground current with a predefined current set point and output a fault indication signal if the ground current exceeds the predefined current set point. The fault indication signal results in the grounding switch being open.

The present disclosure relates generally to ground fault detector interrupters and specifically to such interrupters designed for alternative energy applications.

### BACKGROUND

Underwriters Laboratories Inc. (UL) is a well-known laboratory that develops standards and test procedures for materials, components, assemblies, tools, equipment and procedures, chiefly dealing with product safety and utility.

UL 1741 is a standard that relates to inverters, converters, controllers and interconnection system equipment for use with distributed energy resources. UL 1741 was revised in November 2005 such that it requires all photovoltaic inverter systems to have a Ground Fault Detector Interrupter (GFDI). A GFDI is a solid-state electronic ground fault detector and interrupter designed to provide direct current (DC) fault protection on power conversion systems.

Specifically, UL 1741 (Section 31.1) states that “inverters or chargers with direct photovoltaic inputs from a grounded photovoltaic array or arrays shall be provided with a ground-fault detector/interrupter (GFDI). The GFDI shall be capable of detecting a ground fault, providing an indication of the fault, interrupting the flow of the fault current, and either isolating the faulted array section or disabling the inverter to cease the export of power.”

Typically, GFDI's operate by measuring a current balance between two conductors and opening a device's contacts if there is a difference in current between the conductors. However, since the photovoltaic array's positive or negative pole has to be grounded, such an arrangement cannot easily be implemented.

Accordingly, although there are a number of commercially available GFDIs, they do not meet the current set points and timings required for this standard, where the photovoltaic array's positive or negative pole has to be grounded.

### SUMMARY

A GFDI is provided for DC fault protection on power conversion systems for alternative energy application where the photovoltaic array's positive or negative pole has to be grounded. The GFDI is designed to fulfill the requirements of section 31 of UL 1741.

Therefore, in accordance with an aspect of the present invention there is provided a ground fault detector interrupter (GFDI) configured for use with a DC power supply, the GFDI comprising: a ground current path coupling a ground terminal of the DC power supply and a system ground; a grounding switch placed in the ground current path; a current detector configured to detect a ground current in the ground current path; and a controller configured to compare the ground current with a predefined current set point and output a fault indication signal if the ground current exceeds the predefined current set point, the fault indication signal resulting in the grounding switch being open.

### BRIEF DESCRIPTION OF THE DRAWINGS

An embodiment of the present invention will now be described by way of example only with reference to the following drawings in which:

FIG. 1 is a block diagram illustrating a Ground Fault Detector Interrupter in accordance with an embodiment of the present invention; and

FIG. 2 is a flow chart illustrating the operation of the GFDI illustrated in FIG. 1.

### DETAILED DESCRIPTION OF THE PREFERRED EMBODIMENT

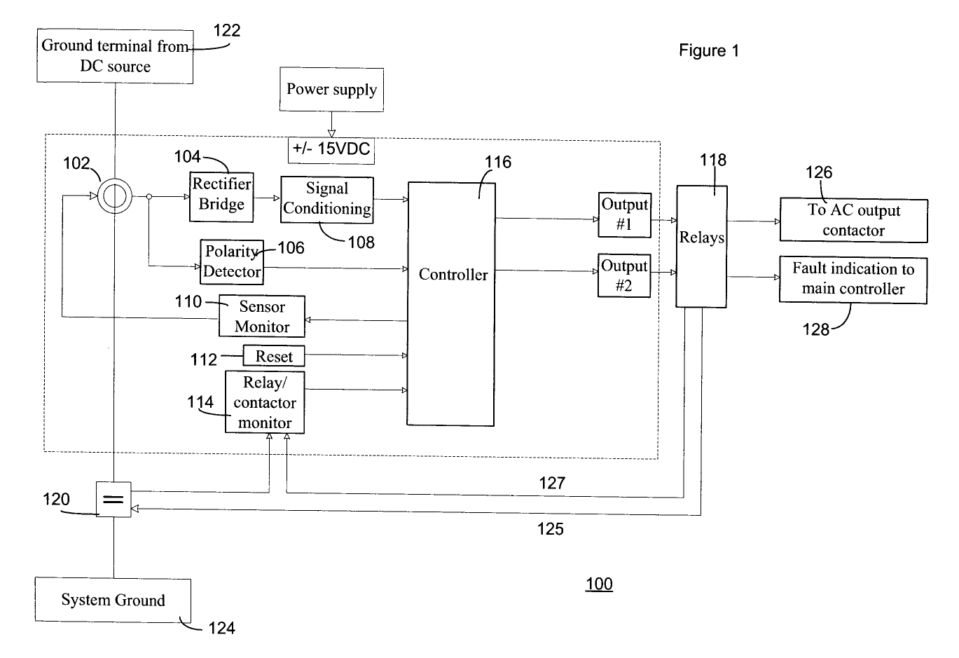

For convenience, like numerals in the description refer to like structures in the drawings. Referring to FIG. 1, a block diagram illustrating a GFDI is shown generally by numeral 100. The GFDI 100 includes a current sensor 102, a bridge rectifier 104, a polarity detector 106, a signal conditioning module 108, a sensor failure monitor 110, a reset 112, a relay and contact monitor 114, a microcontroller 116, relays 118, and a grounding contactor 120.

The current sensor 102 senses a current flowing between a ground terminal 122 (negative or positive pole) of a photovoltaic DC source and a system ground 124. It will be appreciated that the ground terminal refers to whichever one of the terminals is to be coupled to ground. In the present embodiment, the system ground is an enclosure ground, which is a ground terminal of an enclosure in which the GFDI is housed. However, it will be apparent to a person of ordinary skill in the art that another earth ground could be provided as the system ground. The grounding contactor 120 is coupled between the source ground 122 and the enclosure ground 124. Output from the current sensor 102 is provided to the bridge rectifier 104 and the polarity detector 106. Output from the rectifier bridge 104 is coupled to an input on the microcontroller 116 via the signal conditioning module 108. Output from the polarity detector 106 is coupled to an input on the microcontroller 116. Output from the microcontroller 116 is coupled to the relays 118. Output from the relays 118 is coupled to the DC contactor 120 and the relay and contact monitor 114. Output from the grounding contactor 120 is also coupled to the relay and contact monitor 114.

In the present embodiment, the current sensor 102 is a closed loop Hall effect, isolated transducer, which detects the current flowing between the ground and the photovoltaic array. The output of the current sensor 102 is a current that varies to mirror the value of the sensed current.

A bridge rectifier 104 is an arrangement of four diodes, as is known in the art, that provides the same polarity of output current for any polarity of the input current. Persons of ordinary skill in the art would appreciate that the bridge rectifier converts an AC signal to a DC signal. In normal operating mode, the input current will be approximately zero and will deviate from this if a fault occurs. Using a bridge rectifier 104 provides two advantages. A first advantage of the bridge rectifier is avoiding the complication of implementing an absolute value calculator.

A second advantage of the bridge rectifier is allowing the whole range of the microcontroller's analog input to be used to represent the current. Specifically, since the microcontroller 116 has a finite number of bits for analog to digital conversion, the smaller the analog range for conversion, the greater the resolution at which it can be represented. Accordingly, the use of a polarity detector allows a range of 0 to X to be used. Without use of the polarity detector, the range would be −X to X, which is twice as large and would result in a lower resolution.

A signal conditioning block 108 is coupled to the output of the bridge rectifier. The signal conditioning block 108 converts the rectified current signal to a representative voltage signal, in a form that can be read by the microcontroller 116. To ensure the voltage signal is reliable, the signal conditioning block 108 scales and filters the voltage signal. Although an op-amp is utilized in the present embodiment, will be understood that there are other ways to ensure signals are not distorted through interference.

The polarity detector 106 is implemented using an op-amp, as is known in the art. The op-amp detects the polarity of the current sensed by the current sensor 102.

Accordingly, the signal conditioning block 108 provides an absolute value of the voltage signal to the microcontroller 116 and the polarity detector provides the polarity of the voltage signal.

The sensor failure monitor 110 provides an additional level of safety in order to ensure that the current sensor 102 and the signal conditioning block 108 are operating properly. Accordingly, the sensor failure monitor 110 injects a predefined amount of current into the current sensor upon instruction from the microcontroller 116. In the present embodiment, a 60 mA current is injected every second, and the microcontroller 116 monitors the input voltage for the expected change. If there are no changes for three consecutive current injections, the microcontroller 116 will trigger a fault, opening the grounding contactor 120.

The reset 112, is an external input that allows a user to reset the microcontroller 116, the relays 118 and the grounding contactor 120.

The relay and contact monitor 114 monitors feedback from the grounding contactor 120 and the relays 118 to ensure that the grounding contactor 120 is operating as it should. That is, when the relays 118 are active the grounding contactor 120 is closed, and vice versa.

The microcontroller 116 has two inputs for receiving the voltage representing the ground current. Therefore, if one of inputs faults, for example is grounded or connected to a positive supply, the GFDI 100 will continue to function. Similarly, the microcontroller has two outputs which control two relays 124. Although only one output is required, a second, redundant output provides additional protection if one output fails. When the outputs are active, the relays 124 are activated.

In the present embodiment, the relays 124 have four outputs 125, 126, 127 and 128. A first one of the outputs 125 controls whether the grounding contactor 120 is open or closed. In the present embodiment, the grounding contactor 120 is normally open. This default setting provides an additional safety feature since the grounding contactor 120 will be open, inhibiting the flow of current from the DC source 122, in the even that part of the GFDI 100 fails.

A second one of the outputs 128 provides a fault indicator to a main controller (not shown). A third one of the outputs 126 will controls an AC output contactor so the system will cease exporting power from the photovoltaic source. A fourth one of the outputs 127 transmits a status signal to the relay and contactor monitor 114.

The microcontroller 116 is configured to analyse input representing the current detected by the current sensor 102 and determine whether or not a ground fault is detected. The operation of the microcontroller 116 is described as follows.

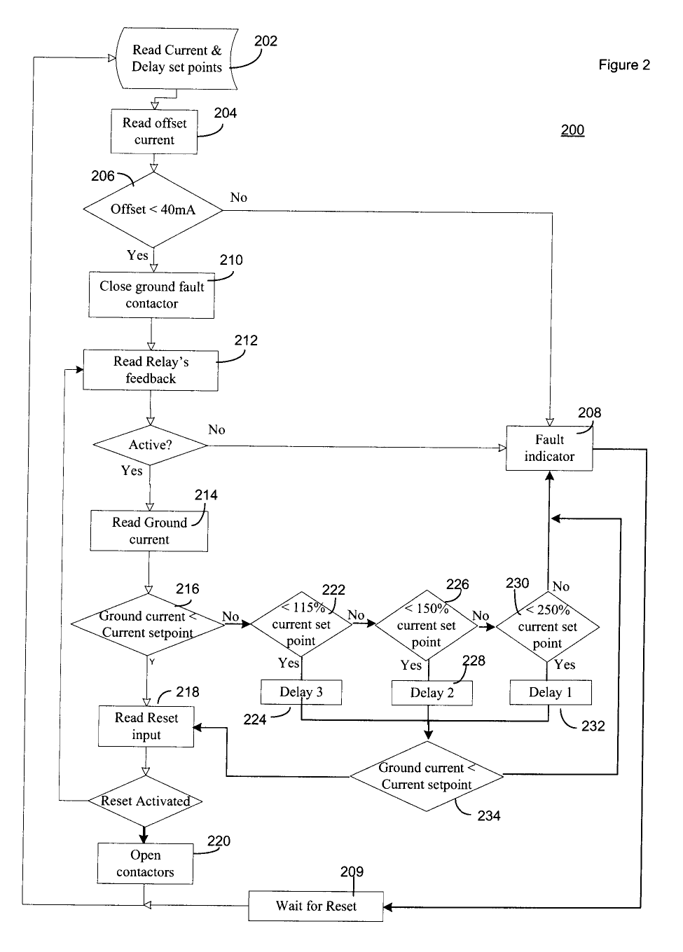

Referring to FIG. 2, a flowchart illustrating the operation of the GFDI is illustrated generally by numeral 200.

Initially, the grounding contactor 120 is open and there is no current flowing between the ground 122 and the enclosure ground 124. At step 202, a current set point and a delay set point are read by the microcontroller 116 and saved into its memory. The current set point represents a threshold for maximum expected current flowing between the ground 122 and the enclosure ground 124, which will be described further on in the description. The delay set point represents a time period and will also be described further on in the description. Both the current set point and the delay set point can be established defaults or customised for a particular implementation.

In step 204, the microcontroller 116 reads the value and polarity of an offset current flowing through the current sensor 102. This current is referred to as an offset current since there should theoretically be a current reading of zero due to the open grounding contactor 120. Accordingly, the offset value represents the non-operating bias of the GFDI 100.

In step 206, the absolute value of the offset current is compared with a predefined offset current threshold. In the present embodiment, the maximum acceptable offset current is 40 mA. If the offset current is greater than the offset current threshold the microcontroller 116 continues at step 208.

At step 208, the microcontroller 116 outputs a fault signal to the relays 118, which in turn open the grounding contactor 120, open the AC output contactor and provide a fault indication to the main controller. The microcontroller waits for a reset command at step 209, before returning to step 202.

If the offset current is less than the offset current threshold the microcontroller 116 continues at step 210. At step 210, the microcontroller 116 outputs a go-ahead signal to the relays 118, which in turn close the grounding contactor 120 and close the AC output contactor.

At step 212, feedback from the relays 118 and the grounding contactor 120 are read by the microcontroller 116 via the relay and contact monitor 114. At this step, the microcontroller 116 is aware that the relays 118 should be active and that the grounding contactor 120 should be closed. If the relays 118 and the grounding contactor 120 are not operating as expected, the microcontroller continues at step 208. If the relays 118 and the grounding contactor 120 are operating as expected, the microcontroller continues at step 214.

At step 214, the microcontroller 116 reads the value of the current flowing between the ground 122 and the enclosure ground 124, also referred to as the ground current. In the present embodiment the microcontroller 116 also combines the offset current with the ground current to get a more accurate representation of the actual ground current. Whether or not the offset current and the ground current are added or subtracted from each other depends on their respective polarities.

For example, for a ground current with a positive polarity and an offset current with a negative polarity, the absolute values of the currents are summed. For a ground current with a positive polarity and an offset current with a positive polarity, the absolute value of the offset current is subtracted from the absolute value of the ground current. For a ground current with a negative polarity and an offset current with a positive polarity, the absolute values of the currents are summed. For a ground current with a negative polarity and an offset current with a negative polarity, the absolute value of the offset current is subtracted from the absolute value of the ground current.

At step 216, it is determined whether or not the ground current is less than the current set point. As previously described, the current set point is the maximum expected ground current that is considered acceptable by the GFDI. In the present embodiment, the current set point can range between 0.5 A and 6 A, although other values may be acceptable, as will be appreciated by a person of ordinary skill in the art.

If the ground current is less than the current set point, the microcontroller 116 continues to step 218. At step 218, the reset 112 is checked to determine whether or not an operator has request a system reset. If a reset has not been requested, the microcontroller 116 returns to step 212 and reads the feedback from the relays 118 and the grounding contactor 120.

If a reset has been requested the microcontroller 116 continues to step 220 and outputs a stop signal to the relays 118, which in turn opens the grounding contactor 120 and opens the AC output contactor. The microcontroller 116 then returns to step 202.

Returning to step 216, if it is determined that the ground current is greater than the current set point, the microcontroller 116 continues at step 221. At step 221, the microcontroller determines whether it is more likely that the ground current exceeds the current set point due to a glitch or spike in the ground current as compared to a true fault.

Specifically, at step 222, it is determined whether or not the ground current is within a first range in excess of the current set point. In the present embodiment, the first range is 115% of the current set point. If the ground current is within the first range, at step 224 the microcontroller 116 waits for a first predefined period of time. In the present embodiment, the first period of time is three times the delay set point. In the present embodiment, the delay set point can range between 0.25 seconds and 3 seconds.

After the delay, the microcontroller 116 continues at step 234, at which the ground current is compared against the current set point once again. If the ground current is still greater than the current set point, the microcontroller 116 continues at step 208 as described above. Otherwise, the microcontroller returns to step 218.

At step 226, it is determined whether or not the ground current is within a second range in excess of the current set point. In the present embodiment, the second range is between 115% and 150% of the current set point. If the ground current is within the second range, at step 228 the microcontroller 116 waits for a second predefined period of time. In the present embodiment, the second predefined period of time is twice the delay set point. After the delay, the microcontroller 116 continues at step 234 as described above.

At step 230, it is determined whether or not the ground current is within a third range in excess of the current set point. In the present embodiment, the third range is between 150 and 250% of the current set point. If the ground current is within the third range, at step 232 the microcontroller 116 waits for a third predefined period of time. In the present embodiment, the third predefined period of time is equal to the delay set point. After the delay, the microcontroller 116 continues at step 234 as described above.

In an alternate embodiment, the microcontroller 116 determines whether the ground current exceeds the current set point due to a glitch or spike as follows. If the ground current is greater than the set current point, a timer is started. In the present embodiment, the duration of the time is set in accordance with the difference between the ground current and the set current point, similar to the previous embodiment. The ground current is continuously monitored. If the ground current falls below the current set point before the timer expires, the microcontroller 116 returns to normal operation. If, however, the ground current does not fall below the current set point before the timer expires, the microcontroller 116 opens the grounding contactor 120, indicating a fault.

It will be apparent to a person of ordinary skill in the art that the examples given above are provided for illustrative purposes only and are in no way intended to limit the scope of the description. For example, the threshold and set points are merely exemplary. Further, although the description above refers to a microcontroller 116, other types of controllers, either analog or digital, can be implemented to achieve the same function, as will be appreciated by a person of ordinary skill in the art. Yet further, although the use of bridge rectifier provides the advantages previously discussed, embodiments can be implemented in which it is not required.

Accordingly, although preferred embodiments of the invention have been described herein, it will be understood by those skilled in the art that variations may be made thereto without departing from the spirit of the invention or the scope of the appended claims.

1. A ground fault detector interrupter (GFDI) configured for use with a direct current (DC) power supply, the GFDI comprising:
a ground current path coupling a ground terminal of the DC power supply and an system ground;
a grounding switch placed in the ground current path;
a current detector configured to detect a ground current in the ground current path; and
a controller configured to compare the ground current with a predefined current set point and output a fault indication signal if the ground current exceeds the predefined current set point, the fault indication signal resulting in the grounding switch being open.

2. The GFDI of claim 1, further comprising a sensor failure monitor configured to monitor operation of the current sensor.

3. The GFDI of claim 2, wherein the sensor monitor monitors the operation of the current sensor by injecting a predefined additional current into the ground current at predefined intervals.

4. The GFDI of claim 1, further comprising a relay and switch monitor for monitoring operation of the relays and the grounding switch, and providing feedback to the controller.

5. The GFDI of claim 1, further comprising a reset input for enabling an operator to reset the GFDI.

6. The GFDI of claim 5, wherein activation of the reset opens the grounding switch.

7. The GFDI of claim 1, wherein the controller is further configured to inhibit the likelihood of a false fault indication signal by waiting a predefined time period and rechecking the comparison between the ground current and the current set point before outputting the fault indication.

8. The GFDI of claim 1 wherein the DC power supply is a photovoltaic array.

9. The GFDI of claim 1, wherein the system ground is an enclosure ground.

10. The GFDI of claim 1, wherein the controller is a microcontroller.

11. The GFDI of claim 1 wherein each element of the GFDI includes a redundant circuit.
